(19) United States
(12) Patent Application Publication
(10) Pub. No.: US 2025/0291706 A1
(43) Pub. Date: Sep. 18, 2025

(54) CODE CLEANING

(71) Applicant: Beijing Zitiao Network Technology Co., Ltd., Beijing (CN)

(72) Inventor: Junyu Yue, Beijing (CN)

(21) Appl. No.: 19/076,236

(22) Filed: Mar. 11, 2025

(30) Foreign Application Priority Data
Mar. 12, 2024 (CN) 202410281929.X

(51) Int. Cl. G06F 11/3668

(52) U.S. Cl. CPC G06F 11/3688

(57) ABSTRACT

The embodiment of the disclose provides a method and device, and medium of code cleaning. A specific embodiment of the method comprises the following steps: running a target test case; obtaining metadata of a target class through reflection of the target class in a target bytecode called in the target test case; determining, based on the metadata, a dependency relationship between members comprised in the target class; determining real values of the members associated with the dependency relationship based on the running of the target test case; determining a dead branch in a decision structure comprised in the target class based on the real values; and deleting a corresponding statement of the dead branch from a source code corresponding to the target class.

### CROSS-REFERENCE

The present application claims priority to Chinese Patent Application No. 202410281929.X, filed on Mar. 12, 2024, and entitled “METHOD, APPARATUS, DEVICE AND MEDIUM FOR CODE CLEANING”, the entirety of which is incorporated herein by reference.

### FIELD

The embodiment of the disclosure relates to the technical field of code cleaning, in particular to methods, apparatuses, devices and medium of code cleaning.

### BACKGROUND

Existing code cleaning schemes generally include dynamic code cleaning schemes and static code cleaning schemes. Wherein, the dynamic code cleaning scheme mainly determines the dead code in the code based on whether each statement included in the code is executed in the actual running of the code. The static code cleaning scheme is mainly to perform code cleaning based on a result of the syntactic analysis for the code statements without running the code. For example, a syntax pattern matching is performed on a statement in the code, and dead code is determined based on the matching result. However, in the existing dynamic code cleaning scheme, there are problems that branches that may be in effect usually cannot be traversed in actual running of the code, so that the dead code cannot be accurately determined. However, in the existing static code cleaning scheme, often in actual production scenarios, the writing style of the code development user is often difficult to completely match the code template, so that the range of the static code cleaning scheme is limited.

Therefore, there is a need for a new code cleaning method.

### SUMMARY

The embodiment of the invention describes a code cleaning method and device, equipment and a medium.

According to a first aspect, a method of code cleaning is provided, including:
running a target test case; obtaining metadata of a target class through reflection of the target class in a target bytecode called in the target test case; determining, based on the metadata, a dependency relationship between members comprised in the target class; determining real values of the members associated with the dependency relationship based on the running of the target test case;
determining a dead branch in a decision structure comprised in the target class based on the real values; and deleting a corresponding statement of the dead branch from a source code corresponding to the target class.

According to a second aspect, an apparatus for code cleaning is provided, including:
a running unit configured to run a target test case, obtain metadata of a target class through reflection of the target class in a target bytecode called in the target test case, determine a dependency relationship between members comprised in the target class based on the metadata; and determine real values of the members associated with the dependency relationship based on the running of the target test case;
a cleaning unit configured to determine a dead branch in a decision structure comprised in the target class based on the real values; and delete a corresponding statement of the dead branch from a source code corresponding to the target class.

According to a third aspect, a computer-readable storage medium is provided, where a computer program is stored, and when the computer program is executed in a computer, the computer is enabled to perform the method according to the first aspect.

According to a fourth aspect, an electronic device is provided, including a memory and a processor, where the memory stores executable code, and when the processor executes the executable code, the method in the first aspect is implemented.

The embodiment of the disclosure provides a method, apparatus, device and medium of code cleaning. Firstly, a target test case may be run, obtaining metadata of a target class through reflection of the target class in a target bytecode called in the target test case; determining, based on the metadata, a dependency relationship between members comprised in the target class; determining real values of the members associated with the dependency relationship based on the running of the target test case. Then, determining a dead branch in a decision structure comprised in the target class based on the real values; and deleting a corresponding statement of the dead branch from a source code corresponding to the target class. Through the method, the true dead code can be identified more accurately in combination with the analysis result of the metadata of the bytecode and the real running value of the class member.

### BRIEF DESCRIPTION OF DRAWINGS

FIG. 1 illustrates a schematic diagram of a static code cleaning scheme;

FIG. 2 illustrates a schematic diagram of a dynamic code cleaning scheme;

FIG. 3 illustrates a schematic diagram of a method of code cleaning according to some embodiments of the present disclosure;

FIG. 4 illustrates a schematic flowchart of a method of code cleaning according to some embodiments of the present disclosure;

FIG. 5 illustrates a schematic diagram of metadata of a class according to some embodiments of the present disclosure;

FIG. 6 illustrates a schematic diagram of a class member dependency relationship graph according to some embodiments of the present disclosure;

FIG. 7 illustrates a schematic block diagram of an apparatus of code cleaning according to some embodiments of the present disclosure;

FIG. 8 illustrates a schematic structural diagram of an electronic device suitable for implementing an embodiment of the present disclosure;

FIG. 9 illustrates a schematic structural diagram of a storage medium suitable for implementing the embodiments of the present disclosure.

### DETAILED DESCRIPTION

The technical solutions provided in this specification are further described in detail below with reference to the accompanying drawings and embodiments. It is to be understood that the specific embodiments described herein are merely for explaining the relevant disclosure, rather than limiting the disclosure. In addition, it should be noted that, for ease of description, only parts related to the present disclosure are shown in the accompanying drawings. It should be noted that, in the case of no conflict, the features in the embodiments and embodiments of the present disclosure may be combined with each other.

In the description of implementations of the present disclosure, the terms “including” and similar terms should be understood to include “including but not limited to”. The term “based on” should be understood as “based at least in part on”. The terms “one/one kind of implementation” or “the implementation” should be understood as “at least one implementation”. The term “some implementations” should be understood as “at least some implementations”. Other explicit and implicit definitions may also be included below.

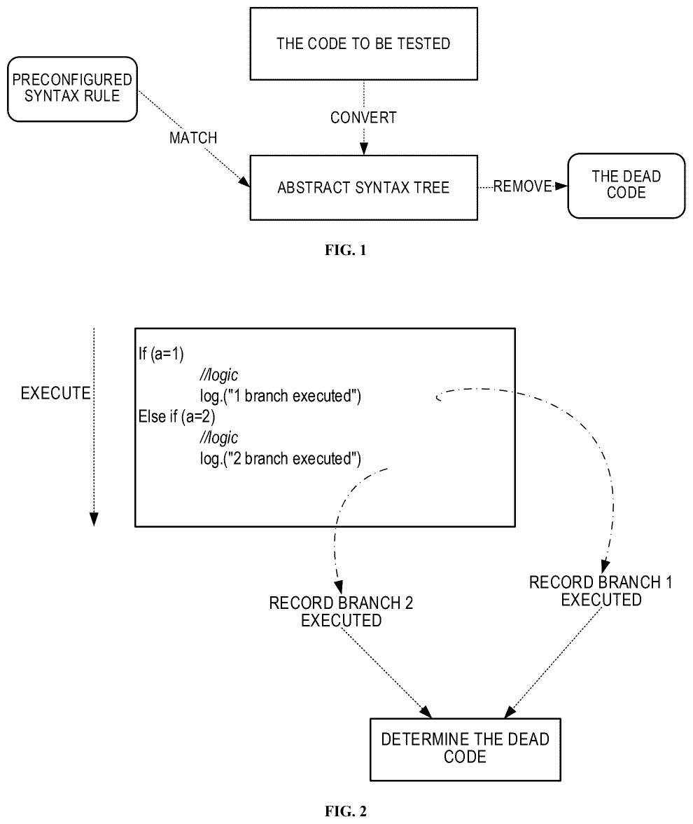

As mentioned above, existing code cleaning schemes generally include a dynamic code cleaning scheme and a static code cleaning scheme. Wherein, the static code cleaning scheme is mainly to perform code cleaning based on a result of the syntactic analysis for the code statement without running the code. For example, a syntax pattern matching is performed on a statement in the code, and dead code is determined based on a matching result. Dynamic Code Cleaning Scheme. The dead code in the code is determined mainly based on whether each statement included in the code is executed in the actual running of the code. For example, FIG. 1 illustrates a schematic diagram of a static code cleaning scheme. As shown in FIG. 1, the code to be tested may be converted into an abstract syntax tree. Then, that is matched with the syntax tree according to the preconfigured syntax rule, the syntax element in the syntax tree is replaced according to the matching result, and then the cleared code is generated according to the syntax tree after the element replacement, that is, the update code after the dead code is removed from the code to be tested. However, the problem existing in this solution lies in that, on the one hand, in an actual production scenario, the preconfigured syntax rule is often difficult to completely match the writing style of different code development users, and the code with different writing styles is not necessarily a dead code, so that the applicable scope of the static code cleaning scheme is limited. On the other hand, static code cleaning schemes usually rely on source code analysis, and for example, analysis of source code of different language types often relies on different pre-work such as head file inclusion or code module import, engineering structure adaptation and the like, and it is difficult to perform generalized code cleaning. In the third aspect, since the static code cleaning scheme does not be running through the code but is only analyzed by the code structure, not only the calculation complexity is high in the analysis process, but the problem that the analysis result (for example, the class member value used for deciding the branch execution) is not consistent with the real running condition easily occurs.

For another example, an existing dynamic code cleaning scheme detects whether the execution statements are actually executed by running the detected code and inserting additional statements behind the execution statements of each conditional branch in the decision structure. The method has the advantages that the code proxy can be executed according to the real running state of the code. FIG. 2 illustrates a schematic diagram of a dynamic code cleaning scheme, as shown in FIG. 2, for example, the tested code includes an if decision structure. Additional statements may be added behind the execution statements of each conditional branch of the decision structure. For example, an execution statement log. (“1 branch executed”) is added behind the execution statement logic1 of a=1 conditional branch; and an execution statement log. (“2 branch executed”) is added behind the execution statement logic2 of a=2 conditional branch, to detect and record whether logic1 and logic2 are executed. Then, the dead code that is not covered in the run may be determined from the above records. However, the disadvantage of this scheme lies in that in an actual production occasion, although many statements in the executed code are not executed, they are still undeletable useful codes. For example, some codes need to be executed under special time conditions (e.g., on a particular festival). Neither of the running of these codes are covered at other times, but they are virtually impossible to delete. Especially for large software, since the complexity of running conditions of the code statements included therein is usually high, it is often difficult to perform code cleaning through the dynamic cleaning scheme.

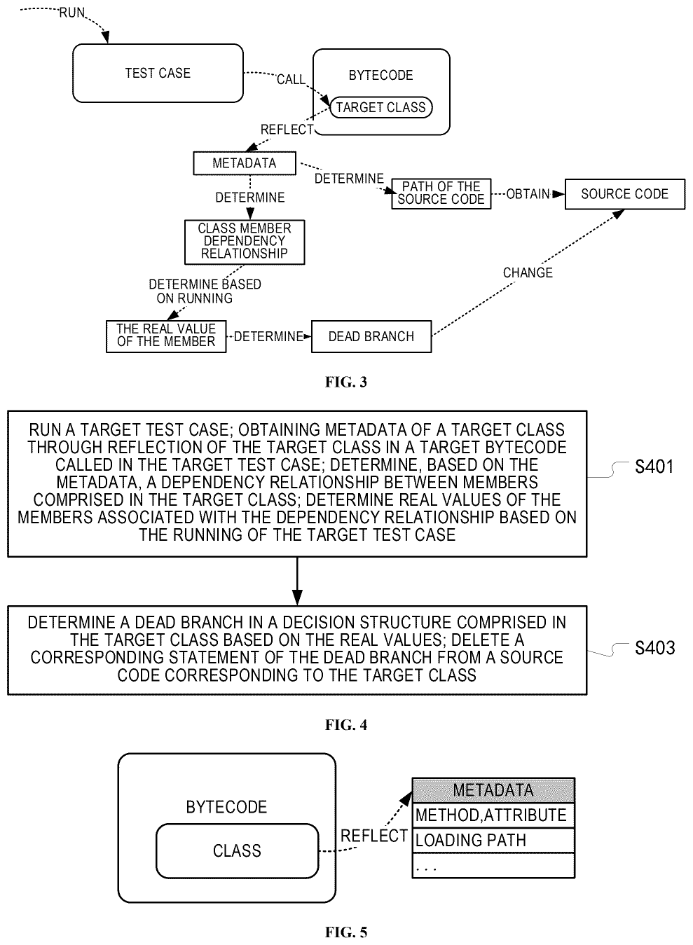

To resolve the foregoing technical problem, embodiments of the present disclosure provide a method of code cleaning. FIG. 3 illustrates a schematic diagram of a method of code cleaning according to some embodiments of the present disclosure. As shown in FIG. 3, in some embodiments, for example, a test case may be run, and a target class in a bytecode called in the running is reflected to obtain metadata of the target class, and a dependency relationship between members comprised in the target class is determined based on the metadata. And the real values of the class members associated with the dependency relationship are determined based on the running of the target test case. Further, a dead branch in the decision structure included in the target class may be determined based on the obtained real values of the class members. Alternatively, the storage path of the source code corresponding to the target class may be obtained based on the metadata of the target class, and the source code corresponding to the target class is acquired accordingly, and the corresponding statement of the dead branch is deleted from the source code. The method has the advantages that on one hand, the member dependency relationship of the called class is obtained through analyzing the metadata of the class in code running. In addition, real values of each member in the member dependency relationship are obtained by actual running of the code. Then, the dead branch in the code is determined based on the real value. In other words, the method obtains a class member dependency relationship that is usually obtained by statically analyzing code in code running. And in the code running, the obtained member real values in the class member dependency relationship, and then the dead branch is determined based on the member real value. Compared with a conventional static code cleaning scheme preformed purely depended on code analysis, the dead branch is determined based on the real value of the member in the dependency relationship of the class member in the running, and the determination result of the real dead code is more accurate. Compared with a conventional dynamic code cleaning scheme preformed purely depended on code execution, the method determines the associated member value based on the class member dependency relationship, and can accurately locate and obtain the key member value for determining the decision result. This is an effect that cannot be achieved by the dynamic code cleaning scheme that do not analyze dependency relationship. Furthermore, the accuracy of this scheme in determining dead code is also unattainable by conventional dynamic code cleaning schemes. On the other hand, because the member dependency relationship of the class is obtained through the reflection of the called class in the running of the test case. There is no need to perform conventional static code analysis, pre-work such as head file inclusion or code module import, engineering structure adaptation, and the like. Thus, a simpler and more generalized code cleaning scheme can be provided relative to a conventional static code cleaning scheme. In a third aspect, with respect to a conventional static code cleaning scheme, a member real value may be obtained based on code running without obtaining a predicted value through a high complexity analysis process. Therefore, the code cleaning result is more accurate, the execution process is more convenient, and the efficiency is higher.

A detailed process of the method is further described below.

FIG. 4 is a schematic flowchart of a method of code cleaning method according to some embodiments of the present disclosure. As shown in FIG. 4, the method includes at least the following steps:

Step S401, run a target test case; obtaining metadata of a target class through reflection of the target class in a target bytecode called in the target test case; determine, based on the metadata, a dependency relationship between members comprised in the target class; determine real values of the members associated with the dependency relationship based on the running of the target test case;

Step S403: determine a dead branch in a decision structure comprised in the target class based on the real values; delete a corresponding statement of the dead branch from a source code corresponding to the target class.

Firstly, in step S401, a target test case is run, metadata of a target class is obtained through reflection of a target class in a target bytecode called in the target test case, and a dependency relationship between members contained in the target class is determined based on the metadata. In this step, the test case (for example, the target test case) may be run, and the target class in the bytecode called in the test case is reflected to obtain the metadata of the target class.

Test Case (Test Case) refers to a test task performed on a specific program (for example, a target program), and is used to verify whether a target program meets a specific test expectation. In different embodiments, the target program for the target program may be a program used for different specific services or purposes, which is not limited in this specification. In different embodiments, the test cases may also be different specific types of test cases. For example, in an embodiment, the target test case may include one or more of a unit test case, a function test case, and a control experiment test case.

The target bytecode may be a bytecode of the target program for the target test case. Bytecode is an intermediate code that is converted from source code during compilation. It is typically more abstract than source code and therefore can be more easily optimized and converted. The bytecode provides a platform-independent code representation such that the code can run on different platforms without requiring recompilation. A class member refers to an element in a class, including, for example, a data member (variable or attribute) and a member function (method). Therefore, in an embodiment, the members included in the target class may include one or more of variables, methods, and attributes included in the target class.

Reflection, a technique that interacts with a class or object at runtime. By reflection, metadata of a class may be acquired dynamically at runtime. In different embodiments, for the reflection of the target class in the bytecode called in the target test case, different specific manners may be used. In an embodiment, the target class in the bytecode corresponding to the target code called in the target test case may be reflected based on the bytecode control framework ASM. Metadata of a class refers to data describing a class. Metadata of the class may be obtained by reflection, as previously described. In different embodiments, the metadata may include different information. FIG. 5 illustrates a schematic diagram of metadata of a class according to some embodiments of the present disclosure. In the example shown in FIG. 5, the obtained metadata of the class may include, for example, a method, an attribute, a method or an attribute included in the class, a load path of the class, and the like.

Based on the metadata, a dependency relationship between members comprised in the target class may be determined. Specifically, a dependency relationship between members may be determined based on a call between members of a class. In an embodiment, the metadata of the plurality of target classes may also be obtained by reflection of a plurality of classes in the target bytecode called in the target test case. Further, a dependency relationship between members of a same target class in the plurality of target classes and a dependency relationship among members of different target classes in the plurality of target classes are determined according to metadata of the plurality of target classes. In different embodiments, the plurality of target classes in the target bytecode called in the target test case may be different specific classes based on different target test cases, which is not limited in this specification. In the foregoing manner, the member dependency relationship between the target class in the target bytecode and the member dependency relationship between the target classes may be conveniently identified, thereby forming the dependency relationship of the complete target class member.

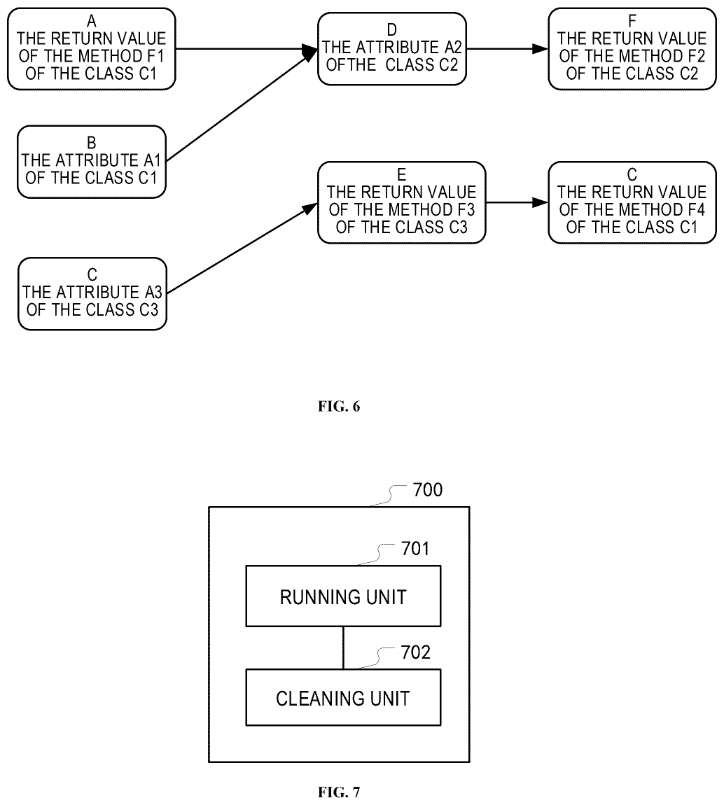

In an example, a dependency relationship of a complete target class member may be represented, for example, in a class member dependency graph. A node in the node represents a class member, and a directed edge between the nodes represents a dependency relationship between members. FIG. 6 illustrates a schematic diagram of a class member dependency relationship graph according to some embodiments of the present disclosure. As shown in FIG. 6, for example, in the running of the target test case, the class C1, the class C2, and the class C3 are called directly or indirectly (by calling the intermediate class). The node F represents the return value of the method F2 of the class C2, and the execution of the F2 calls the attribute A2 (node D) of the class C2. Therefore, the F node depends on the D node, or the value of the F node depends on the value of the D node. In addition, the return value (node A) of method F1 of class C2 and the attribute A1 (node B) of the class C1 are called in the calculation of the attribute A2. Thus, the D node depends on node A and node B. Similarly, node C (the return value of the method F4 of the class C1) depends on node E (the return value of the method F3 of the class C3), and node E depends on node C (the attribute A3 of the class C3).

After determining the dependency relationship between the members included in the target class, the real value of the class member associated with the dependency relationship may be determined based on the running of the target test case. Specifically, in the running of the target test case, the actual value of each class member in the dependency relationship existing in the class directly or indirectly called by the test case may be read. For method members, the return value of the method can be used as a member value. Therefore, in an embodiment, the real value of the member associated with the dependency relationship may include a return value of the method. For example, in the example shown in FIG. 6, in the running of the target test case, a value of a member represented by each node may be read after the member represented by each node is called. Through the above manner, the actual value of the class member associated with the dependency relationship can be conveniently obtained without complex code analysis.

In an embodiment, the target running environment may be constructed by using the environment simulator; and the real value of the member associated with the dependency relationship is determined based on the running of the target test case in the target running environment. In different embodiments, different specific software or hardware forms of environmental simulators may be employed. In different embodiments, the specific manner of constructing the target operating environment may also be different. In a specific embodiment, one or more of a simulated network environment, a simulated storage environment, an environment input value or an environment configuration value for the target test case, and update values of a member associated with the dependency relationship may be constructed. According to the method, the real running environment in different scenes can be simulated, and the real value of the class member in the execution of the target test case in the real running environment under various different scenes can be obtained more accurately. Further, in subsequent steps, the dead codes are identified more accurately based on the real values of the class members in various different scenarios.

Then, in step S403, the dead branch in the decision structure included in the target class may be determined based on to the real value of the class member obtained in step S401. In different embodiments, the specific forms of the decision structures included in the target class may be different. In an embodiment, for example, one or more of an If decision structure, a switch decision structure and a case decision structure may be included. In different embodiments, the specific calculation that the decision structure determines which branch is executed by based on the class member value, and the specific class member value used to determine which branch is executed may be different, which is not limited in the present specification. In one example, such as that shown in FIG. 6, the attribute A2 (D) in the class membership dependency is used in the If decision structure to determine which one or which if branches are executed. Therefore, the useful branch and the dead branch in the if branch can be determined based on the real value of the attribute A2 obtained in step S401.

In different embodiments, the specific manner of determining the dead branches may also be different. In an embodiment, the abstract syntax tree corresponding to the target class may be generated based on the source code corresponding to the target class; and the dead branch in the decision structure included in the target class may be determined based on the real value and the abstract syntax tree (AST). Specifically, for example, the source code may be converted into an abstract syntax tree, and then the syntax node corresponding to the dead branch in the abstract syntax tree is determined based on the real value. In an embodiment, the source code corresponding to the target class may be obtained by: determining a load path of the target class based on the metadata of the target class; obtaining a storage path of the source code of the target class based on the load path of the target class and a predetermined correspondence between the load path of the target class and the storage path of the source code of the target class; and obtaining the source code based on the storage path. Through the above manner, dead branches can be determined quickly based on the abstract syntax tree.

As described above, in different embodiments, the specific form of the decision structure and the real value of the member used for decision may be different. Further, in different embodiments, the determined specific dead branches may also be different, which is not limited in this specification.

After the dead branch is determined, the corresponding statement of the dead branch may be deleted from the source code corresponding to the target class. In different embodiments, specific manners of deleting dead branch corresponding statements may be different. In a specific embodiment, after determining the syntax node corresponding to the dead branch through the abstract syntax tree, the syntax node is deleted from the abstract syntax tree, and the updated source code is generated based on the abstract syntax tree after the syntax node corresponding to the dead branch is deleted. The effect is to delete corresponding statements of dead branches from the original source code. Through the above manner, corresponding statements of dead branches can be efficiently deleted from the source code based on the abstract syntax tree.

FIG. 7 illustrates a schematic block diagram of an apparatus of code cleaning according to some embodiments of the present disclosure. The apparatus is configured to perform the method shown in FIG. 4. As shown in FIG. 7, the apparatus 700 includes:

The running unit 701 is configured to run a target test case, obtain metadata of a target class through reflection of the target class in a target bytecode called in the target test case, determine a dependency relationship between members comprised in the target class based on the metadata; and determine a real value of the member associated with the dependency relationship based on the running of the target test case;

The cleaning unit 702, configured to determine a dead branch in a decision structure comprised in the target class based on to the real values; and delete a corresponding statement of the dead branch from a source code corresponding to the target class.

An embodiment of the present disclosure further provides an electronic device, including a memory and a processor, where the memory stores executable code, and when the processor executes the executable code, the method shown in FIG. 4 is implemented.

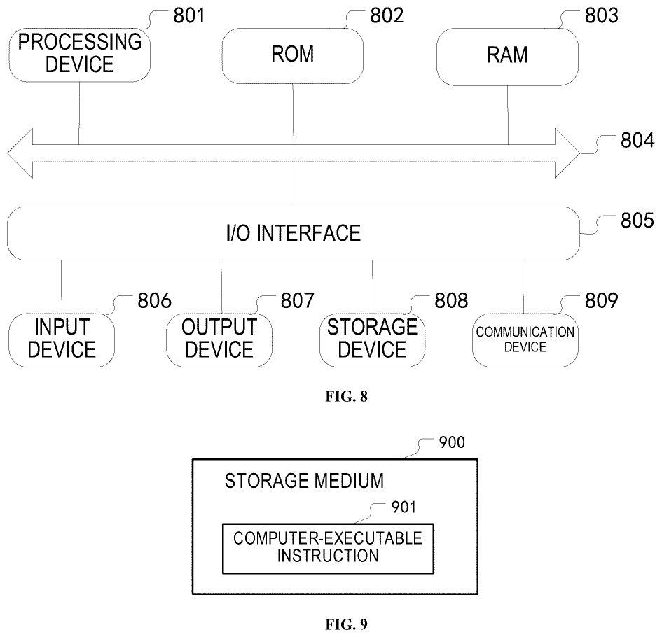

FIG. 8 illustrates a schematic structural diagram of an electronic device 800 suitable for implementing an embodiment of this application. The electronic device 800 shown in FIG. 8 is merely an example, and should not impose any limitation on the functions and the use scope of the embodiments of this application.

As shown in FIG. 8, the electronic device 800 may include a processing device (for example, a central processing unit, a graphics processor, etc.) 801. The processing device 801 may be a general-purpose processor, a digital signal processor (DSP), a microprocessor, or a microcontroller, or may further include an application specific integrated circuit (ASIC), a field-programmable gate array (FPGA) or another programmable logic device, a discrete gate or transistor logic device, or a discrete hardware component, and may perform various appropriate actions and processing according to a program stored in a read-only memory (ROM) 802 or a program loaded into a random access memory (RAM) 803 from a storage device 808. In RAM803, various programs and data required by the operation of the electronic device 800 are also stored. The processing devices 801, ROM802 and RAM803 are connected to each other via a bus 804. Input/output (I/O) interface 805 is also connected to bus 804.

Generally, the following devices may be connected to the I/O interface 805: an input device 806 including, for example, a touch screen, a touch pad, a keyboard, a mouse, etc.; an output device 807 including, for example, a liquid crystal display (LCD), a speaker, a vibrator, etc.; a storage device 808 including, for example, a magnetic tape, a hard disk, etc.; and a communication device 809. The communication device 809 may allow the electronic device 800 to communicate wirelessly or wired with other devices to exchange data. While FIG. 8 shows an electronic device 800 having various devices, it should be understood that it is not required to implement or have all illustrated devices. More or fewer devices may alternatively be implemented or provided. Each block shown in FIG. 8 may represent one apparatus, or may represent multiple apparatuses as required.

In particular, according to an embodiment of the present application, the process described above with reference to the flowchart may be implemented as a computer software program. For example, embodiments of the present disclosure include a computer program product comprising a computer program embodied on a computer-readable medium, the computer program comprising program code for performing the method shown in the flowchart. In such embodiments, the computer program may be downloaded and installed from the network through the communication device 809, or installed from the storage device 808, or installed from ROM802. When the computer program is executed by the processing apparatus 801, the foregoing functions defined in the code cleaning method provided in the embodiments of this application are performed.

An embodiment of the present disclosure further provides a computer-readable storage medium having a computer program stored thereon, and when the computer program is executed in a computer, the computer is enabled to perform the code cleaning method shown in FIG. 4 according to an embodiment of this application. FIG. 9 illustrates a schematic diagram of a storage medium according to an embodiment of this application. For example, as shown in FIG. 8, the storage medium 900 may be a non-transitory computer-readable storage medium for storing non-transitory computer-executable instruction 901. When the non-transitory computer executable instruction 901 is executed by the processor, the code cleaning method provided in this embodiment of this application may be implemented, for example, when the non-transitory computer executable instruction 901 is executed by the processor, one or more steps in the code cleaning method provided in the embodiments of this application may be performed. For example, the storage medium 900 may be applied to the foregoing electronic device, for example, the storage medium 900 may include a memory in the electronic device. For description of the storage medium 900, reference may be made to the description of the memory in the embodiment of the electronic device, and details are not described herein again. For specific functions and technical effects of the storage medium 900, refer to the description of the code cleaning method provided in the embodiments of this application, and details are not described herein again.

It should be noted that the computer-readable medium of the embodiments of the present disclosure may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may include, but are not limited to, an electrical connection having one or more wires, a memory card of a smartphone, a storage component of a tablet, a portable computer diskette, a hard disk of a personal computer, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In embodiments of the present disclosure, a computer-readable storage medium may be any tangible medium containing or storing a program that may be used by or in connection with an instruction execution system, apparatus, or device. In an embodiment of the present disclosure, the computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, including but not limited to: wires, optical cables, Radio Frequency (RF), and the like, or any suitable combination thereof.

The computer-readable medium described above may be included in the electronic device; or may be separately present without being assembled into the electronic device. The computer-readable medium carries one or more programs, and when the one or more programs are executed by the server, the electronic device implements the code cleaning method provided in the embodiments of this application.

Computer program code for carrying out the operations of embodiments of the present disclosure may be written in one or more programming languages or combinations thereof, including an object oriented programming language such as Java, Smalltalk, C++, and also conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions. The units involved in the embodiments of the present disclosure may be implemented in software, or may be implemented in hardware. The name of the unit does not constitute a limitation on the unit itself in some cases. The functions described above may be performed, at least in part, by one or more hardware logic components. For example, without limitation, exemplary types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

Various embodiments in this specification are described in a progressive manner, and parts that are the same and similar between the embodiments may be referred to each other, and each embodiment focuses on differences from other embodiments. In particular, for the storage medium and the computing device embodiment, since it is substantially similar to the method embodiment, the description is relatively simple, and reference may be made to some descriptions of the method embodiments at the relevant parts.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to). Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

The objects, technical solutions and beneficial effects of the embodiments of the present invention are further described in detail above with reference to specific embodiments. Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims. It should be understood that the above is only a specific embodiment of the embodiments of the present disclosure, and is not intended to limit the protection scope of the present disclosure, and any modification, equivalent substitution, improvement and the like made on the basis of the technical solutions of the present disclosure should be included within the protection scope of the present disclosure.

What is claimed is:

1. A method of code cleaning, comprising:
running a target test case;
obtaining metadata of a target class through reflection of the target class in a target bytecode called in the target test case;
determining, based on the metadata, a dependency relationship between members comprised in the target class;
determining real values of the members associated with the dependency relationship based on the running of the target test case;
determining a dead branch in a decision structure comprised in the target class based on the real values; and
deleting a corresponding statement of the dead branch from a source code corresponding to the target class.

2. The method of claim 1, wherein determining the dead branch in the decision structure comprised in the target class based on the real values comprises:
generating an abstract syntax tree corresponding to the target class based on the source code corresponding to the target class; and
determining the dead branch in the decision structure comprised in the target class based on the real value and the abstract syntax tree.

3. The method of claim 1, wherein the reflection of the target class in the bytecode called in the target test case comprises:
a reflection of a target class in a bytecode corresponding to target code called in the target test case based on a bytecode control framework abstract syntax tree manipulation ASM.

4. The method of claim 1, wherein the members comprised in the target class comprise one or more of a variable, a method, and an attribute comprised in the target class;
the real values of the members associated with the dependency relationship comprises a return value of the method.

5. The method of claim 1, wherein obtaining the metadata of the target class through the reflection of the target class in the target bytecode called in the target test case comprises:
obtaining metadata of a plurality of target classes through reflection of the plurality of target classes in a bytecode called in the target test case;
wherein determining the dependency relationship between members comprised in the target class based on the metadata comprises:
determining, based on the metadata of the plurality of target classes, a dependency relationship between members of a same target class in the plurality of target classes and a dependency relationship between members of different target classes in the plurality of target classes.

6. The method of claim 1, wherein the source code of the target class is obtained by:
determining a loading path of the target class based on the metadata of the target class;
obtaining a storage path of the source code of the target class based on the loading path of the target class and a predetermined correspondence between the loading path of the target class and the storage path of the source code of the target class; and
obtaining the source code based on the storage path.

7. The method of claim 1, wherein determining the real values of the members associated with the dependency relationship based on the running of the target test case comprises:
constructing a target running environment through an environment simulator; and
determining the real values of the members associated with the dependency relationship based on the running of the target test case in the target running environment.

8. The method of claim 1, wherein constructing the target running environment comprises:
constructing one or more of a simulated network environment, a simulated storage environment, an environment input value or an environment configuration value for the target test case, and update values of the members associated with the dependency relationship.

9. The method of claim 1, wherein the target test case comprises one or more of a unit test case, a function test case, and a control experiment test case.

10. An electronic device, comprising:
at least one processor; and
at least one memory, coupled to the at least one processor and storing instructions for execution by the at least one processor, the instructions, when executed by the at least one processor, causing the electronic device to perform operations comprising:
running a target test case;
obtaining metadata of a target class through reflection of the target class in a target bytecode called in the target test case;
determining, based on the metadata, a dependency relationship between members comprised in the target class;
determining real values of the members associated with the dependency relationship based on the running of the target test case;
determining a dead branch in a decision structure comprised in the target class based on the real values; and
deleting a corresponding statement of the dead branch from a source code corresponding to the target class.

11. The electronic device of claim 10, wherein determining the dead branch in the decision structure comprised in the target class based on the real values comprises:
generating an abstract syntax tree corresponding to the target class based on the source code corresponding to the target class; and
determining the dead branch in the decision structure comprised in the target class based on the real value and the abstract syntax tree.

12. The electronic device of claim 10, wherein the reflection of the target class in the bytecode called in the target test case comprises:
a reflection of a target class in a bytecode corresponding to target code called in the target test case based on a bytecode control framework abstract syntax tree manipulation ASM.

13. The electronic device of claim 10, wherein the members comprised in the target class comprise one or more of a variable, a method, and an attribute comprised in the target class;
the real values of the members associated with the dependency relationship comprises a return value of the method.

14. The electronic device of claim 10, wherein obtaining the metadata of the target class through the reflection of the target class in the target bytecode called in the target test case comprises:
obtaining metadata of a plurality of target classes through reflection of the plurality of target classes in a bytecode called in the target test case;
wherein determining the dependency relationship between members comprised in the target class based on the metadata comprises:
determining, based on the metadata of the plurality of target classes, a dependency relationship between members of a same target class in the plurality of target classes and a dependency relationship between members of different target classes in the plurality of target classes.

15. The electronic device of claim 10, wherein the source code of the target class is obtained by:
determining a loading path of the target class based on the metadata of the target class;
obtaining a storage path of the source code of the target class based on the loading path of the target class and a predetermined correspondence between the loading path of the target class and the storage path of the source code of the target class; and
obtaining the source code based on the storage path.

16. The electronic device of claim 10, wherein determining the real values of the members associated with the dependency relationship based on the running of the target test case comprises:
constructing a target running environment through an environment simulator; and
determining the real values of the members associated with the dependency relationship based on the running of the target test case in the target running environment.

17. The electronic device of claim 10, wherein constructing the target running environment comprises:
constructing one or more of a simulated network environment, a simulated storage environment, an environment input value or an environment configuration value for the target test case, and update values of the members associated with the dependency relationship.

18. The electronic device of claim 10, wherein the target test case comprises one or more of a unit test case, a function test case, and a control experiment test case.

19. A non-transitory computer-readable storage medium having a computer program stored thereon, the computer program, when executed by a computer, causing the computer to perform the method comprising:
running a target test case;
obtaining metadata of a target class through reflection of the target class in a target bytecode called in the target test case;
determining, based on the metadata, a dependency relationship between members comprised in the target class;
determining real values of the members associated with the dependency relationship based on the running of the target test case;
determining a dead branch in a decision structure comprised in the target class based on the real values; and
deleting a corresponding statement of the dead branch from a source code corresponding to the target class.

20. The non-transitory computer-readable storage medium of claim 19, wherein determining the dead branch in the decision structure comprised in the target class based on the real values comprises:
generating an abstract syntax tree corresponding to the target class based on the source code corresponding to the target class; and
determining the dead branch in the decision structure comprised in the target class based on the real value and the abstract syntax tree.
